(19) United States
(12) Patent Application Publication
(10) Pub. No.: US 2012/0247657 A1
(43) Pub. Date: Oct. 4, 2012

(54) SUBSTRATE TRANSFER METHOD AND SUBSTRATE TRANSFER APPARATUS

(76) Inventors: Masayuki Yamamoto, Osaka (JP); Yukitoshi Hase, Kameyama-shi (JP)

(21) Appl. No.: 13/423,879

(22) Filed: Mar. 19, 2012

(30) Foreign Application Priority Data
Mar. 31, 2011 (JP) 2011-079713

(51) Int. Cl. B32B 38/18; B32B 38/10

(52) U.S. Cl. 156/249; 156/538

(57) ABSTRACT

A ring frame and a substrate are held on each table via an adhesive tape. An annular separation member presses the adhesive tape between the ring frame and the substrate, thereby separating the adhesive tape from the ring frame. After separation, the adhesive tape hung down is held by a holding member. Surfaces of the ring frame and the substrate are transferred onto a new adhesive tape while the adhesive tape is pressed by a joining roller. Then the separated adhesive tape is held by the holding member. The substrate joined to the new adhesive tape to be integrated with the frame is moved upward and horizontally. Thereby the separated adhesive tape is separated from the surface of the substrate.

### BACKGROUND OF THE INVENTION

1. Field of the Invention

This invention relates to substrate transfer method and apparatus for performing a desired treatment to various substrates, such as a semiconductor wafer, a circuit board, and an LED (Light Emitting Diode), adhesively held on a ring frame via an adhesive tape, and then transferring the substrate onto a new adhesive tape.

2. Description of the Related Art

The following treatment is performed to a semiconductor wafer as an example of a substrate. A circuit pattern with numerous components is formed on a surface of a typical semiconductor wafer (hereinafter simply referred to as a “wafer”), and then a protective tape is joined to the surface of the wafer for protection. Grinding or polishing is performed in a back grinding process to a rear face of the wafer having the protected surface, thereby obtaining the wafer having a desired thickness. The wafer is adhesively held on the ring frame via a supporting adhesive tape (dicing tape) for reinforcement of the wafer. Subsequently, the protective tape is separated from the thinned wafer, and the wafer is transferred to perform a dicing process.

The wafer adhesively held on the ring frame differs in its processing step in accordance with semiconductor chips to be manufactured. For instance, the semiconductor chips are micromachined using laser dicing. Here, when the dicing is performed on the surface of the wafer with a circuit pattern formed thereon, the circuit may be damaged due to heat. Thus, the rear face of the wafer needs to be half-cut prior to back grinding. When each chip that is made through breaking of the half-cut wafer is mounted on a desired position, the adhesive tape and protective tape on the surface of the chip is separated until a collet sucks the surface of the chips for transportation. The adhesive tape is joined again to the rear face of the wafer with the adhesive tape separated therefrom, and the wafer is adhesively held on a new ring frame. Subsequently, the wafer is subject to breaking. That is, the wafer needs to be transferred onto a new ring frame prior to breaking.

Upon this transfer, an adhesive surface of the adhesive tape exposed between the ring frame and the wafer is prevented from adhering to an adhesive surface of an adhesive tape that is to be newly joined. That is, the ring frame is relatively moved away from the wafer to elastically deform the adhesive tape, whereby a gap is produced in a thickness direction. See Japanese Patent Publication No. 2011-29434.

The above conventional method, however, has the following problems.

Specifically, the conventional method is performed effectively for use of a soft adhesive tape. On the other hand, where a hard (e.g., PET) adhesive tape is adopted for giving rigidity to a wafer, the wafer is hard to elastically deform. Thus, a sufficient gap cannot be produced when the ring frame is moved away from the wafer. That is, adhesion of the adhesive tapes each other cannot be avoided completely. Moreover, upon separation of the adhered adhesive tapes, excessive tensile force acts on the wafer to damage the wafer. Such problem may also arise.

### SUMMARY OF THE INVENTION

This invention has been made regarding the state of the art noted above, and its primary object is to provide a substrate transfer method and a substrate transfer apparatus that enables accurate transfer of a wafer onto a new adhesive tape.

Additional features of the invention will be set forth in the description which follows, and in part will be apparent from the description, or may be learned by practice of the invention.

This invention is configured as under to achieve the above object. This invention discloses a substrate transfer method for transferring a substrate onto a new adhesive tape, the substrate being adhesively held on a frame via a supporting adhesive tape. The method includes the steps of a first separating step holding the frame and the substrate onto each table on a side of the adhesive tape and pressing the adhesive tape between the frame and the substrate by a separation member to separate the adhesive tape from the frame; a holding step holding the separated adhesive tape by a holding member through bending the adhesive tape toward a table that holds the semiconductor wafer; a transferring step transferring the substrate onto a new adhesive tape by a joining member on a non-holding surface side of the substrate; and a second separating step separating from the substrate the adhesive tape separated from the frame while holding the adhesive tape by the holding member and moving the substrate that is transferred onto the new adhesive tape to be integrated with the frame vertically and horizontally.

According to this method, a hard adhesive tape that has difficulty in elastically deforming is pressed by the separation member between the frame and the substrate to be separated from the frame. The adhesive tape separated from the frame is bent toward the table that holds the substrate, and is held by the holding member on a side surface of the table. Consequently, a gap can be produced in the thickness direction between the non-holding surface of the substrate and the adhesive surface of the separated adhesive tape. Thus, the adhesive surface of the new adhesive tape may be prevented from adhering to the adhesive surface of the separated adhesive tape upon transfer of the substrate onto the new adhesive tape on the non-holding surface side of the substrate.

The substrate may be transferred onto the new adhesive tape as follows in the above transferring step. First, the substrate may be transferred onto the new adhesive tape through laminating the frame having the new adhesive tape being joined thereto in advance on the frame with the substrate and then pressing the adhesive tape. Second, a new frame may be laminated on the frame with the substrate, and then the adhesive tape may be joined to the new frame while being pressed. Consequently, the substrate may be transferred onto the adhesive tape. Third, the substrate may be transferred onto the adhesive tape while the adhesive tape is pressed and joined on the non-holding surface side of the frame with the substrate. That is, the substrate is transferred onto the adhesive tape while the adhesive tape is joined on an opposite side of the same frame.

The separation member having a slit may be adopted. In the transferring step in this case, an outer periphery of the separated adhesive tape is forcibly bent to be enclosed with the separation member. The holding member presses the adhesive tape against the side surface of the table for supporting the substrate through the slit of the separation member.

According to this method, the separation member forcibly bends a separating edge of the adhesive tape separated from the frame while covering the adhesive surface. Consequently, the adhesive surface of the new adhesive tape may surely be prevented from adhering to the adhesive surface of the separated adhesive tape.

Moreover, in the second separating step, the separated adhesive tape is preferably held on one end thereof in a separating direction.

According to this method, the edge of the adhesive tape away from the separating direction is free. Consequently, separation stress concentrates at a separation starting point of the adhesive tape. Thus, the separated adhesive tape can be accurately separated from the substrate.

This invention also discloses a substrate transfer apparatus for transferring a substrate onto a new adhesive tape, the substrate being adhesively held on a frame via a supporting adhesive substrate. The apparatus includes a substrate-holding table for mounting and holding the substrate, the substrate and the frame being joined to the adhesive tape; a frame-holding table for mounting and holding the frame; a separation mechanism for pressing the adhesive tape between the frame and the substrate by a separation member to separate the adhesive tape from the frame; a holding mechanism for holding the separated adhesive tape through bending the adhesive tape toward the substrate-holding table; a transfer mechanism for transferring the substrate onto a new adhesive tape by a joining member on a non-holding surface side of the substrate; and a separation unit for separating the separated adhesive tape from the substrate while holding the separated adhesive tape and moving the substrate that is transferred onto the new adhesive tape to be integrated with the frame vertically and horizontally.

This configuration may achieve suitable implementation of the above method.

For instance, the holding member in this aspect may be a clamping mechanism that presses the separated adhesive tape against the side surface of the substrate-holding table.

Moreover, the separation member in this aspect having a slit forcibly bends and covers an outer periphery of the separated adhesive tape. The clamping mechanism presses the adhesive tape at the slit against the side surface of the substrate-holding table. Such configuration is preferable.

According to this configuration, the separation member forcibly bends the adhesive tape separated from the frame while covering the adhesive surface. Consequently, the adhesive surface of the new adhesive tape may surely be prevented from adhering to the adhesive surface of the separated adhesive tape upon transfer.

it is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding, of the invention and are incorporated in and constitute a part of this specification, illustrate embodiments of the invention, and together with the description serve to explain the principles of the invention.

FIG. 1 is a plan view showing a basic configuration of a transfer apparatus.

FIG. 2 is a perspective view of a mount frame.

FIG. 3 is a front view of a mount-frame supply section.

FIG. 4 is a plan view of a first transport mechanism.

FIG. 5 is a front view of the first transport mechanism.

FIG. 6 is a front view of a transfer mechanism.

FIG. 7 is a plan view of the transfer mechanism.

FIG. 8 is a sectional view of a die.

FIG. 9 is a front view partly showing a separation unit.

FIG. 10 is a plan view partly showing the separation unit.

FIG. 11 is a side view partly showing the separation unit.

FIG. 12 is a plan view of an adhesive tape joining section.

FIG. 13 is a front view of the adhesive tape joining section.

FIG. 14 is a plan view of a reversing unit.

FIG. 15 is a front view of the reversing unit.

FIGS. 16 to 23 are explanatory views each showing a transferring process.

FIG. 24 is a front view of a transfer mechanism according to one modification.

FIGS. 25 to 30 are explanatory views each showing a transferring process of the apparatus according to the modification.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set firth herein. Rather, these embodiments are provided so that this disclosure is thorough, and will fully convey the scope of the invention to those skilled in the art, in the drawings, the size and relative sizes of layers and regions may be exaggerated for clarity. Like reference numerals in the drawings denote like elements.

One embodiment of this invention will be described hereunder with reference to the drawings.

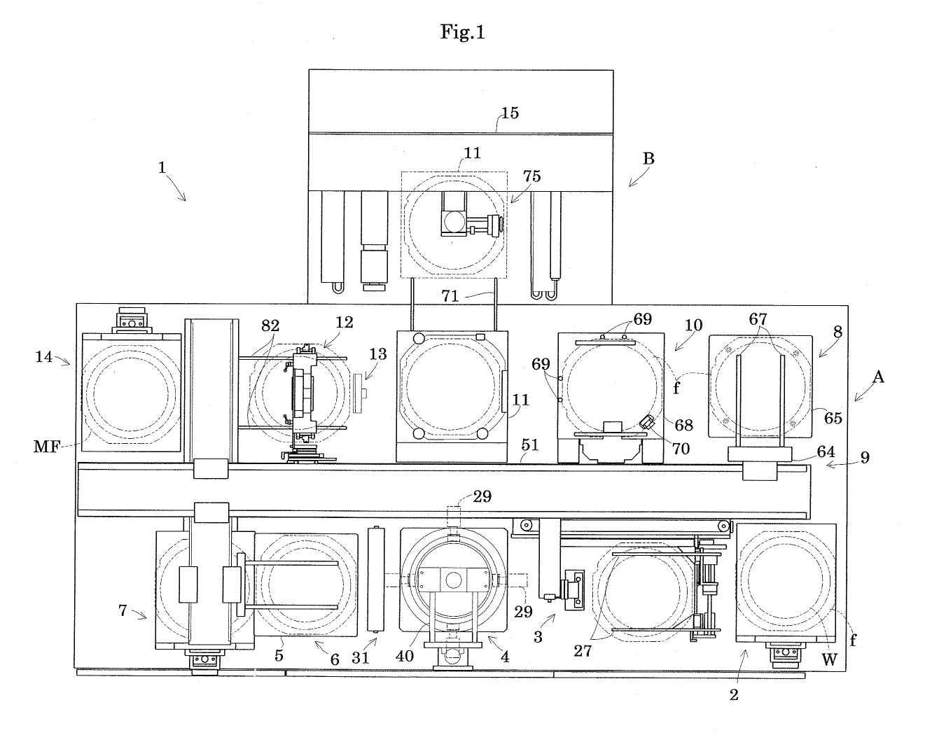

FIG. 1 is a plan view showing a basic configuration of an adhesive tape joining apparatus according to the one embodiment of this invention.

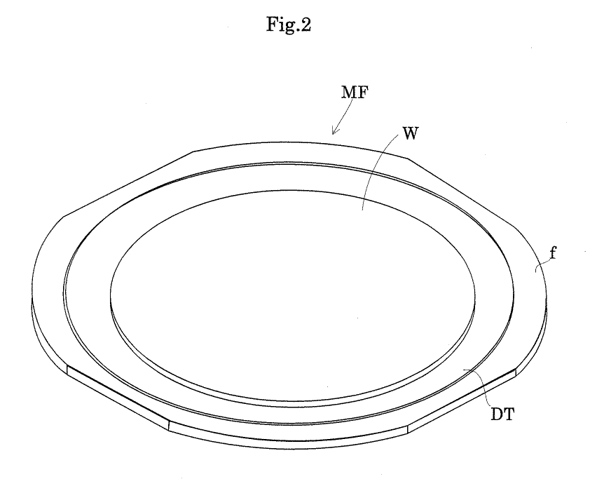

As shown in FIG. 2, a substrate transfer apparatus 1 transfers a semiconductor wafer W (hereinafter, simply referred to as a “wafer W”) on a mount frame MF that is manufactured by joining an adhesive tape DT to a ring frame f and a circuit-formation surface of the wafer W onto a new mount frame MF. The adhesive tape DT used in this embodiment is PET (Polyethylene Terephthalate) in order to give rigidity to the wafer W. This is not limited to such adhesive tape.

As shown in FIG. 1, the substrate transfer apparatus 1 has a laterally extending rectangular section A and a protrusion section B coupled on a center of the rectangular section A so as to protrude upward in plane, thereby having an inverted “T” shape. Here, in the following description, a longitudinal direction of the rectangular section A is defined as a horizontal direction. Moreover, a direction orthogonal to the horizontal direction is defined as upper and lower directions.

The rectangular section A has a mount-frame supply section 2, a first transport mechanism 3, a transfer mechanism 4, a separation unit 5, a tape collecting section 6, and a frame collecting section 7 on the lower side thereof. The rectangular section A has a ring-frame supply section 8, a second transport mechanism 9, an aligner 10, a holding table 11, a reversing unit 12, a pusher 13, and a mount-frame collecting section 14 on the upper side thereof in the longitudinal direction.

The protrusion section B has a tape joining section 15. The tape joining section 15 joins the adhesive tape DT to the ring frame f.

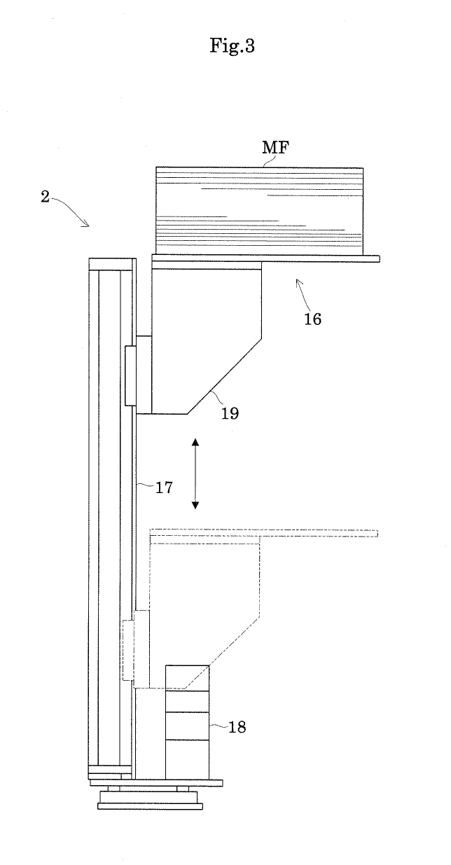

The mount-frame supply unit 2 has a storage section 16. The storage section 16 collects the mount frame MF in a stack manner that is manufactured by adhesively holding the surface of the wafer W on the ring frame f via the adhesive tape DT as in FIG. 3. Here, a circuit-formation face of the wafer W is directed downward. The storage section 16 has an upright rail 17 and a lifting table 19. The upright rail 17 is fixedly coupled to an apparatus framework. The lifting table 19 moves upward and downward in a screw-feed manner by a motor 18 along the upright rail 17. Consequently, the mount-frame supply section 2 enables the mount frame MF placed on the lifting table 19 to move vertically in a pitch feed manner. The frame collecting section 7, the ring-frame supply section 8, and the mount-frame collecting section 14 have the same configuration as the mount-frame supply section 2.

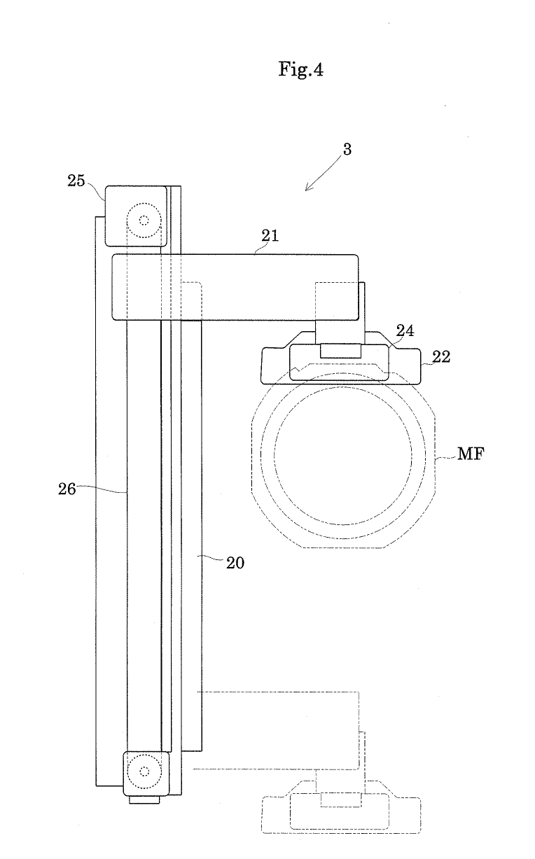

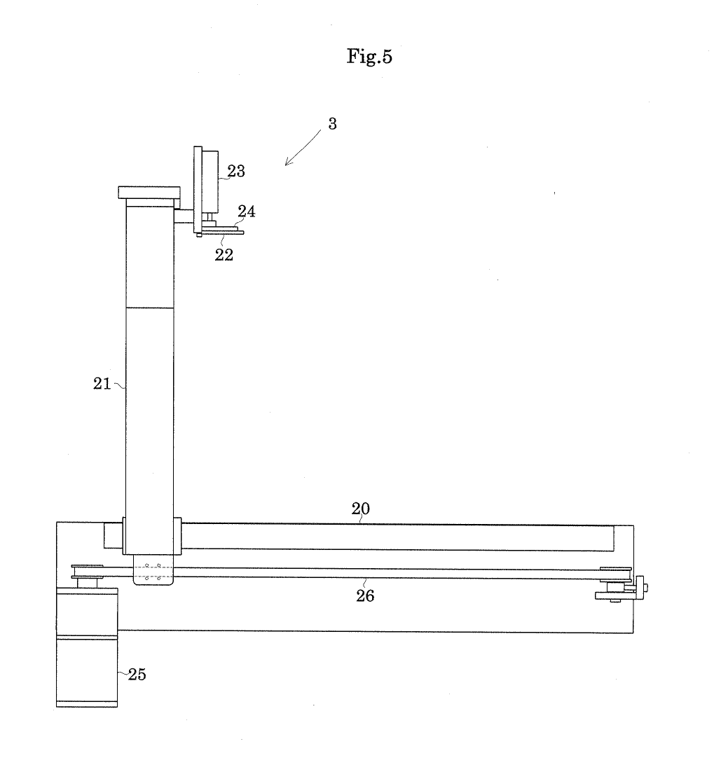

As shown in FIGS. 4 and 5, the first transport mechanism 3 has a chuck piece 24 provided on a movable board 21 that moves horizontally along a guide rail 20. A receiving piece 22 and a cylinder 23 open and close the chuck piece 24. The receiving piece 22 and the chuck piece 24 vertically grasp one end of the mount frame MF. Moreover, the movable board 21 has a bottom coupled to a belt 26 that is moved rotationally by a motor 25. Thus, forward and backward operation of the motor 25 achieves reciprocating motion of the movable board 21 in a horizontal direction. The first transport mechanism 3 moves to place the mount frame MF fed out from the mount-frame supply section 2 onto a pair of guide rails 27 shown in FIG. 1.

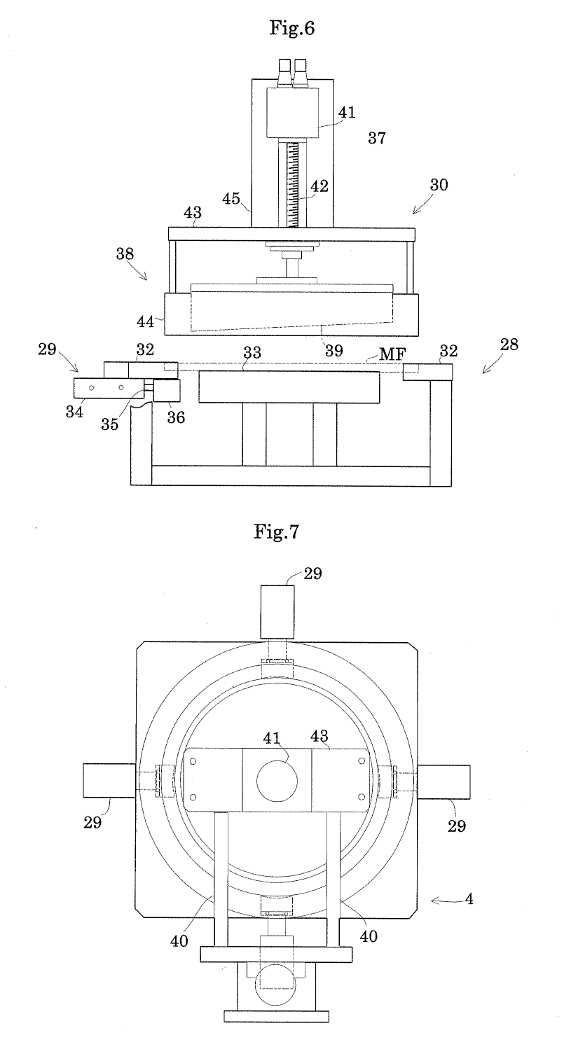

As shown in FIGS. 1, 6 and 7, the transfer mechanism 4 has a holding table 28, a tape holding mechanism 29, a separation mechanism 30, and a joining unit 31.

The holding table 28 is formed of an annular frame holder 32 and a circular wafer holder 33. The frame holder 32 holds the ring frame f of the mount frame MF. The circular wafer holder 33 with a diameter not less than the wafer W holds the wafer W. The frame holder 32 has a plurality of suction holes in a holding surface thereof for suction-holding the ring frame f. The wafer holder 33 has a plurality of suction holes in a holding surface thereof for suction-holding the wafer W. These suction holes are in communication with an external vacuum device. Here, the frame holder 32 corresponds to the frame holding table in this invention. The wafer holder 33 corresponds to the substrate holding table in this invention.

The tape holding mechanism 29 is formed of an air cylinder 34 and a holding member 36 provided at a tip end of a cylinder rod 35. Here, the surface of the holding member 36 is subjected to a releasing treatment, and conforms to a curvature of the side surface of the wafer holder 33. In this embodiment, four tape holding mechanisms 29 are arranged at equal intervals around the wafer holder 33. The number thereof is not particularly limitative. Here, the tape holding mechanism 29 corresponds to the holding mechanism in this invention.

The separation mechanism 30 has a lifting mechanism 37, a frame clamping section 38, and a die 39. The lifting mechanism 37 is provided at a tip end of an arm 40 that extends forward from an upright wall. Specifically, a ball screw 42 is provided that is coupled to a rotation axis of a motor 41 in the lifting mechanism 37 and extends downward. The die 39 is attached via a movable board 43 that moves upward and downward by the ball screw 42.

The frame clamping section 38 includes an annular member 44 on a flange 45 that extends downward from a bottom of the arm 40. The annular member 44 has a diameter approximately equal to the ring frame f.

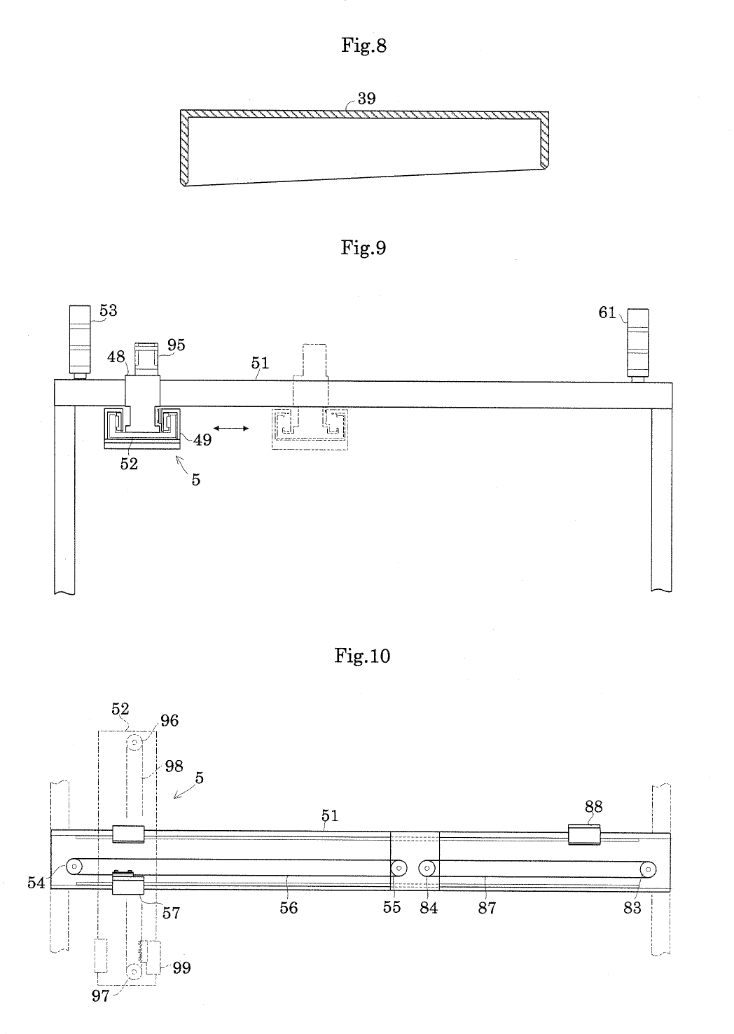

The die 39 is annular. As shown in FIG. 8, the die has a section tapered toward a tip thereof, and the tip is rounded. At least the tip end of the die is subjected to a releasing treatment. The die 39 is also tapered obliquely downward to the left when seen in side view. Here, the die 39 corresponds to the separation member in this invention.

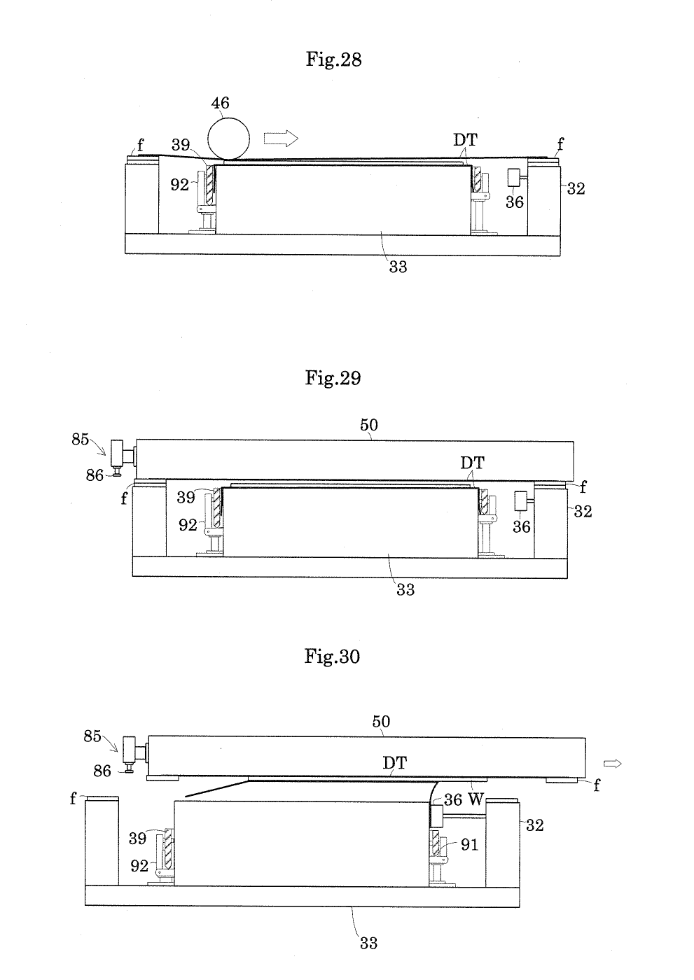

As shown in FIGS. 1 and 28, the joining unit 31 has a joining roller 46 having a surface covered with an elastic material. The joining roller 46 moves vertically within a given level. Moreover, the joining roller 46 rolls from one end toward the other end of the holding table 28.

As shown in FIGS. 9 and 10, the separation unit 5 is formed of a horizontally movable board 48, a forward/backward movable board 49, and a holding unit 50. The horizontally movable board 48 is movable horizontally along a guide rail 51. The forward/backward movable board 49 is movable forward and backward along a guide rail 52 provided in the horizontally movable board 48. The holding unit 50 is movable vertically as to hold the mount frame MF below the forward/backward movable board 49.

A driving pulley 54 is pivotally supported near a left end of the guide rail 51 and is driven by a motor 53 so as to rotate forward/backward. Moreover, an idling pulley 55 is pivotally supported near a center of the guide rail 51. Further, a belt 56 is wound between the driving pulley 54 and the idling pulley 55, and a slide engagement section 57 of the horizontally movable board 48 is coupled to the belt 56. Thus, when the belt 56 rotates forward/backward, the horizontally movable board 48 moves horizontally.

A driving pulley 96 is pivotally supported on an upper side of the horizontally movable board 48 and is driven by a motor 95 so as to rotate forward/backward. Moreover, an idling pulley 97 is pivotally supported on a lower side of the horizontally movable board 48. A belt 98 is wound between the driving pulley 96 and the idling pulley 97, and a slide engagement section 99 of the forward/backward movable board 49 is coupled to the belt 98. Thus, when the belt 98 rotates forward/backward, the forward/backward movable board 49 moves in the forward/backward.

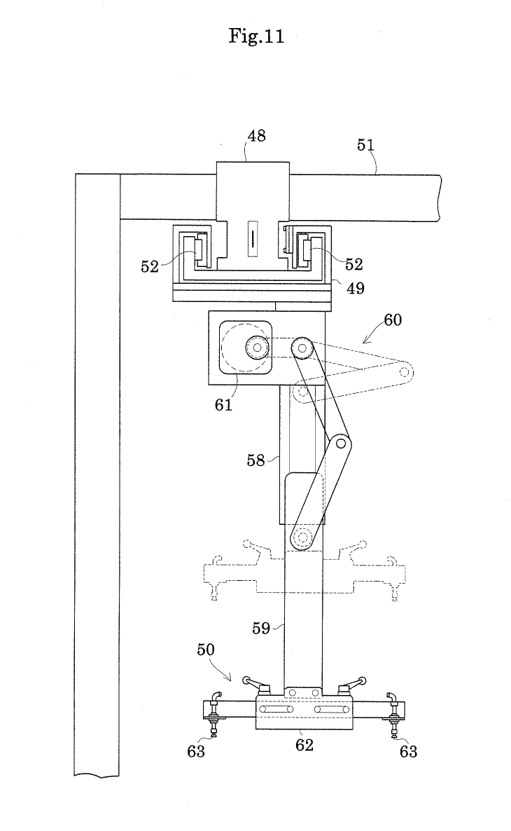

As shown in FIG. 11, the holding unit 50 includes an upright frame 58 connected to a bottom side of the forward/backward movable board 49, a lifting frame 59 supported so as to slide vertically along the upright frame 58, a bendable link mechanism 60 for moving the lifting frame 59 vertically, a motor 61 for bending the bendable link mechanism 60 forward/backward, a suction plate 62 provided at a lower end of the lifting frame 59 for sucking the wafer W, and suction pads 63 provided at a periphery of the suction plate 62. Thus, the holding unit 50 can suction-hold the mount frame MF placed on the holding table 28 to transport the mount frame MF vertically, forward/backward and horizontally. Herein, the suction pad 63 is slidingly adjustable in the horizontal direction in accordance with a size of the ring frame f.

The separation unit 5 can move between the guiding rail 27 on the lower side of the rectangular section A and the frame collecting section 7, between the upper aligner 10 and the reversing unit 12, and between the upper and lower sides of the rectangular section A, which is to be mentioned later. That is, the separation unit 5 of this embodiment functions as the transport mechanism of the ring frame f and the mount frame MF.

The tape collecting section 6 has a collecting box for collecting the adhesive tape DT separated from the mount frame MF as shown in FIG. 23.

As shown in FIG. 1, the second transport mechanism 9 is formed of a horizontally movable board 64 and a holding unit 65. The horizontally movable board 64 can move horizontally along a guide rail 51 similarly to the horizontally movable board 48. The holding unit 65 is provided below the horizontally movable board so as to move vertically for holding the mount frame MF.

As shown in FIGS. 9 and 10, a driving pulley 83 is pivotally supported at a position near a right end of the guide rail 51 and is driven by a motor 61 so as to rotate forward/backward. Moreover, an idling pulley 84 is pivotally supported at a position near a center of the guide rail 51. A belt 87 is wound between the driving pulley 83 and the idling pulley 84, and a slide engagement section 88 of the horizontally movable board 64 is coupled to the belt 87. Thus, when the belt 87 rotates forward/backward, the horizontally movable board 64 moves horizontally.

As shown in FIG. 1, the holding unit 65 includes an upright frame connected to a bottom side of an arm 67 that extends downward from the horizontally movable board 64, a lifting frame supported so as to slide vertically along the upright frame, a motor for moving the upright frame vertically, and suction pads provided on a lower end of the lifting frame. Thus, the holding unit 65 can suction-hold the ring frame f placed on the ring frame supply section 8 to transport the ring frame f vertically and horizontally. Herein, the suction pad is slidingly adjustable in the horizontal direction in accordance with a size of the ring frame f.

The aligner 10 has a holding table 68 for placing the ring frame f, fixing pins 69 for alignment, and an alignment mechanism 70. The alignment mechanism 70 includes a contacting member. The contacting member of the alignment mechanism 70 slides the ring frame f toward the fixing pin 69 and holds it with the fixing pin 69, whereby the ring frame f is aligned.

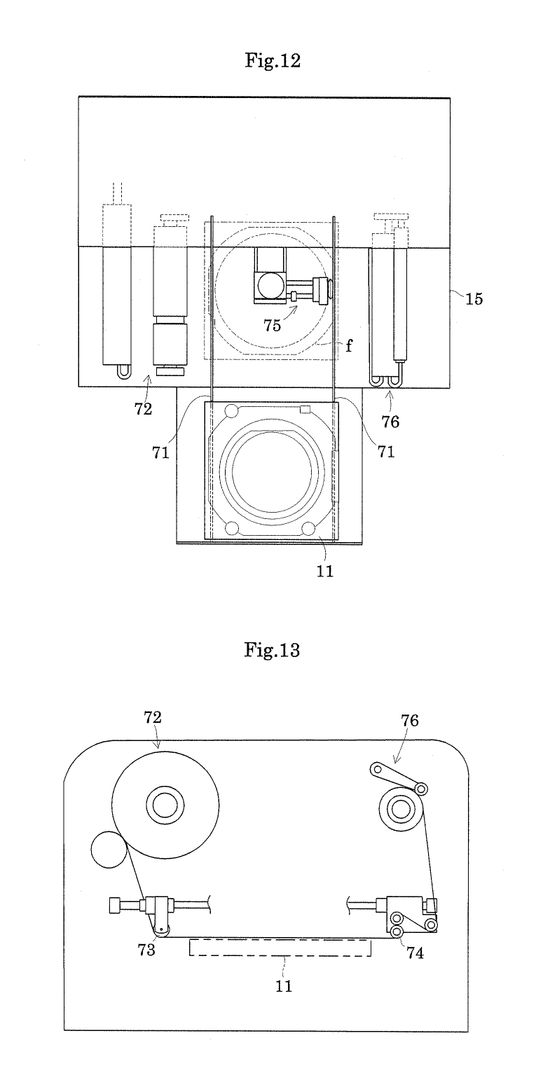

The holding table 11 suction-holds the ring frame f. Moreover, as shown in FIGS. 1 and 12, a drive mechanism reciprocates the holding table 11 along rails 71 between a set position of the ring frame f and the adhesive tape joining section 15.

As shown in FIGS. 12 and 13, the tape joining section 15 has a tape supply section 72, a joining roller 73, a separation roller 74, a tape cutting mechanism 75, and a tape collecting section 76. The tape supply section 72 houses a wide adhesive tape (a dicing tape) DT in a roll form. That is, when the ring frame f placed on the holding table 11 is transported into a tape joining position, the joining roller 73 travels to join the adhesive tape DT on the top surface of the ring frame f. Next, a disk blade turns while the tape cutting mechanism 28 has moved downward, and cuts the joined adhesive tape DT along the ring frame f. Next, the separation roller 74 travels to separate an unnecessary portion of the cut adhesive tape DT, which remains outside a cutting line thereof, from the ring frame f. Simultaneously, the tape collecting section 76 winds up and collects the separated unnecessary tape.

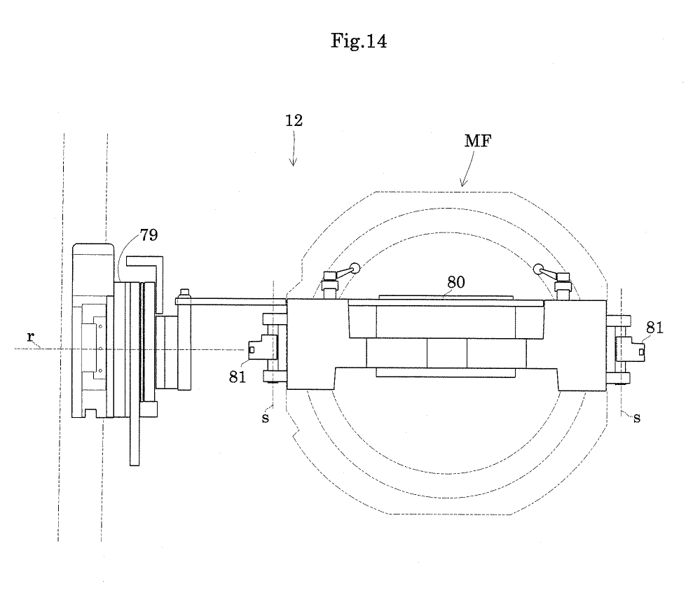

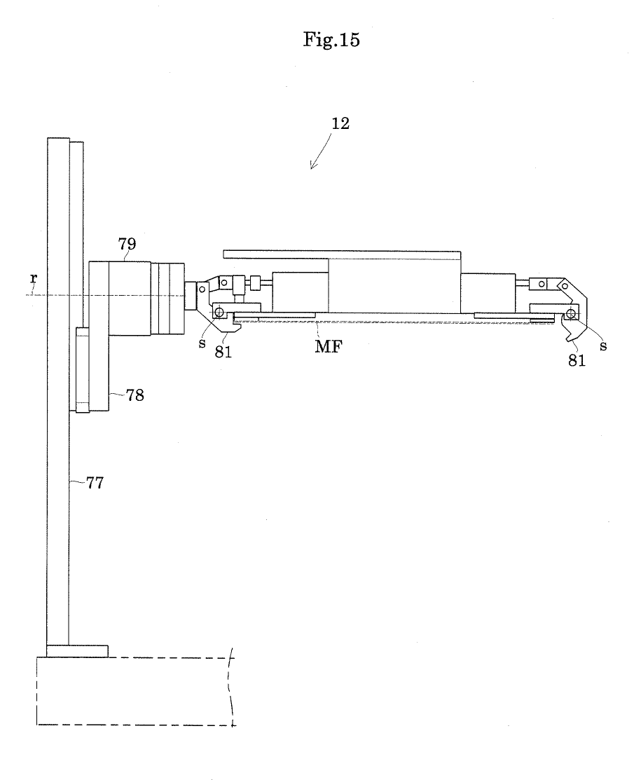

As shown in FIGS. 14 and 15, the reversing unit 12 has the following configuration. That is, a receiving frame 80 that rotates about a horizontal axis r by a rotation actuator 79 is attached in a cantilever manner to a lifting table 78 that moves vertically along a fixed upright rail 77. Moreover, the reversing unit 12 has chuck claws 81 at distal and proximal ends of the receiving frame 80, respectively, so as to rotate about an axis s. The reversing unit 12 receives the mount frame MF having a circuit surface directed downward from the separation unit 5, and then reverses the mount frame MF. As a result, the circuit surface of the mount frame MF is directed upward. Then the reversing unit 12 places the mount frame MF on a guide rail 82.

The pusher 13 pushes out the mount frame MF placed on the guide rail 82 to house it into the mount frame collecting section 14.

Next, description will be given of transferring the wafer W from the mount frame MF subject to a desired treatment with use of the foregoing apparatus to the adhesive tape DT joined to a new ring frame f.

The first transport mechanism 3 holds the mount frame MF housed in the frame supply section 2 in a stack manner with the circuit-formation surface of the wafer W having the adhesive tape DT joined thereto directed downward. Thereafter, the first transport mechanism 3 moves and mounts the mount frame MF on the guide rail 27.

The first transport mechanism 3 moves into a retracted position on the right side. Subsequently, the separation unit 5 moves above the guide rail 27. The separation unit 5 suction-holds the surface of the mount frame MF to place it on the holding table 28 provided in the transferring mechanism 4.

After placing the mount frame MF on the holding table 28, the separation unit 5 moves toward the aligner 10.

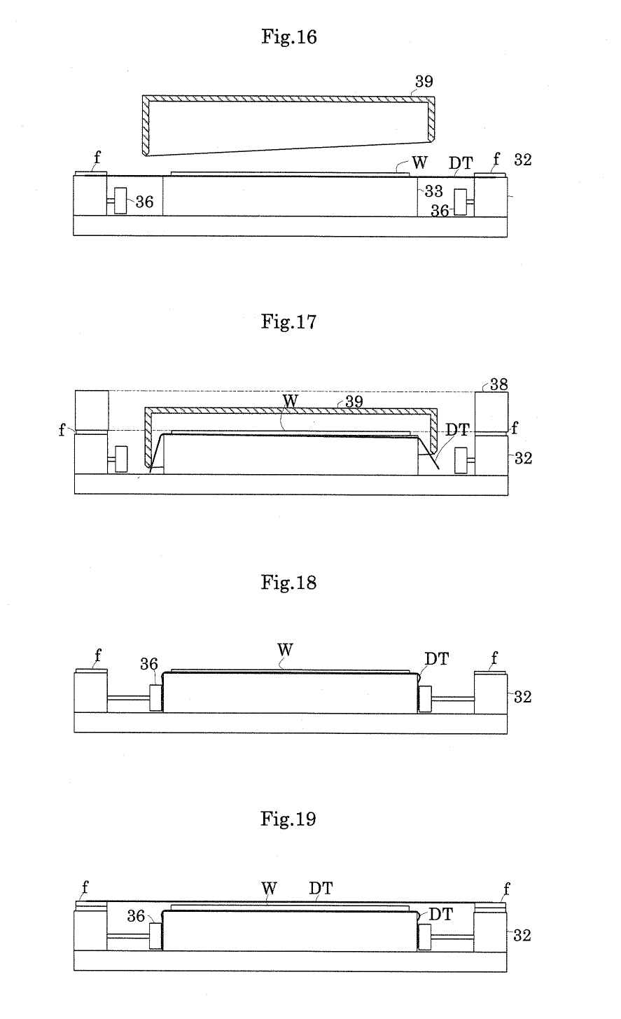

As shown in FIG. 16, the separation mechanism 30 operates upon placing the mount frame MF on the holding table 28. That is, the frame clamping section 38 and the die 39 move downward. The annular member 44 of the frame clamping section 38 reaches the ring frame f, and then the die 39 reaches the adhesive tape DT between the ring frame f and the wafer W. The die 39 moves downward into a given level as shown in FIG. 17 while the frame holder 32 and the annular member 44 hold the adhesive tape DT. Here, the tapered die 39 is pressed downward while contacting the adhesive tape DT at the tip end thereof from one end toward the other end on the lowest end side. Thereby the adhesive tape DT is separated from the ring frame f. The separated adhesive tape DT that protrudes from the wafer holder 33 is bent downward by the die 39.

After the adhesive tape DT is separated, the frame clamping section 38 and the die 39 move upward to their standby positions. Simultaneously, the tape holding mechanism 29 operates, and the holding member 36 presses the outer periphery of the adhesive tape DT against the side wall of the wafer holder 33 to hold the adhesive tape DT.

The mount frame MF is fed out from the mount frame supply section 2. Simultaneously, the second transport mechanism 9 suction-holds the ring frame f to transport it from the ring frame supply section 8 to the aligner 10. The aligner 10 aligns the ring frame f.

After placing the mount frame MF on the holding table 11, the separation unit 5 moves to a position above the aligner 10 and suction-holds the ring frame f to place it on the holding table 11.

The holding table 11 moves to a joining position of the tape joining section 15 while suction-holding the ring frame f.

When the holding table 11 reaches the joining position, the joining roller 73 in FIG. 13 moves downward to roll on the adhesive tape DT. Consequently, the adhesive tape DT is joined to the ring frame f. When the joining roller 73 reaches its termination position, the tape cutting mechanism 75 moves downward to cut the adhesive tape DT while turning the cutter blade along the ring frame f.

Upon completion of cutting the adhesive tape DT, the tape cutting mechanism 75 moves upward, and the separation roller 74 moves to wind up and collect the unnecessary adhesive tape after cut out.

Upon completion of joining the adhesive tape DT to the ring frame f, the holding table 11 moves to an upper side of the rectangular section A in FIG. 1, and then stops. At this position, the separation unit 5 suction-holds the ring frame f for placing it onto the mount frame MF on the holding table 28. That is, as shown in FIG. 19, the mount frame MF from which the adhesive tape DT is separated by the die 39 is laminated with the ring frame f.

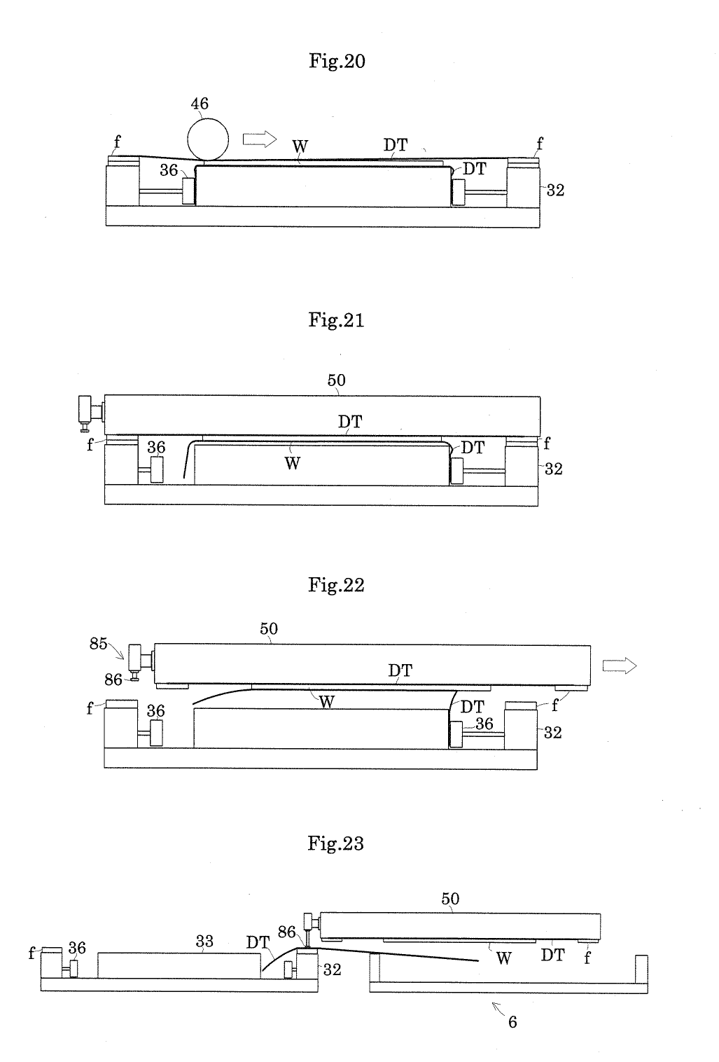

Then the joining roller 46 presses and rolls on the ring frame f while the outer periphery of the adhesive tape DT is held by cooperation of the holding member 36 with the side surface of the wafer holder 33, as shown in FIG. 20. Thereby a new adhesive tape DT is joined to a non-holding surface of the wafer W on the wafer holder 33. When the joining roller 46 reaches its termination position, the separation unit 5 moves to a position above the ring frame f.

The holding unit 50 of the separation unit 5 moves downward to a given level. As shown in FIG. 21, the holding unit 50 suction-holds the mount frame MF transferred onto a new adhesive tape DT to be integrated with the ring frame f. At this time, only the holding member 36 operates. The holding member 36 is in the tape collecting section 6 side, which is a direction where the separation unit 5 moves next. In other words, holding of the adhesive tape DT through press of the other holding member 36 is released. Suction of the ring frame f by the frame holder 32 and suction of the wafer W by the wafer holder 33 is also released.

As shown in FIG. 22, the holding unit 50 moves obliquely upward toward the tape collecting section 6. When reaching a given level, the holding unit 50 moves horizontally. Here, one end of the separated adhesive tape DT is held by the holding member 36 and the side surface of the wafer holder 33. Consequently, the adhesive tape DT is separated from the wafer W from a holding position side as the separation unit 5 moves.

When the holding unit 50 moves into a given position to separate the adhesive tape DT from the rear face of the wafer W, a suction mechanism 85 on the side surface of the holding unit 50 operates. As shown in FIG. 23, the adhesive tape DT is held by the frame holder 32 and a suction member 86. The suction member 86 at the tip of the suction mechanism 85 is subject to a releasing treatment. The adhesive tape is also suction-held by the suction member 86. The holding unit 50 reaches above the tape collecting section 6. Then the suction member 86 releases suction of the adhesive tape DT. Consequently, the adhesive tape DT is collected into the tape collecting section 6 below the holding unit 50. At this time, transfer of the wafer W onto the new ring frame f is completed.

After ejecting the adhesive tape DT from the holding unit 50, the separation unit 5 moves to an upper side of the reversing unit 12. The new mount frame MF suction-held by the holding unit 50 reaches a position opposite to the reversing unit 12. Then suction of the mount frame MF is released, thereby the mount frame MF is placed on the reversing unit 12. Thereafter, the separation unit 5 moves to the mount frame supply section 2 side, and starts transportation of a next mount frame MF.

The chuck claws 81 of the reversing unit 12 with the mount frame MF placed thereon suction-hold the mount frame MF to turn it upside down. That is, the circuit-formation surface of the wafer W is directed upward. After placing the mount frame MF on the guide rail 82 under this state, the reversing unit 12 returns to its standby position on the upper side.

When the mount frame MF is placed on the guide rail 82, the pusher 13 pushes out the mount frame MF to house it into the mount frame collecting section 14.

Thus, a round of the basic operation is completed as mentioned above. The similar operation is to be repeated hereinafter.

According to the apparatus of the foregoing embodiment, the annular die 39 separates a hard adhesive tape with difficulty in elastically deforming from the ring frame f, and bends it downward. Moreover, the adhesive tape DT protruding outward from the wafer holder 33 is sandwiched between the holding member 36 and the side wall of the wafer holder 33. Thus, float of the adhesive tape DT can be suppressed. Consequently, when the ring frame f joined to the new adhesive tape DT is laminated on the mount frame MF having the adhesive tape already separated therefrom, the adhesive surfaces of both adhesive tapes DT do not adhere to each other. That is because a sufficient gap can be obtained between the adhesive surfaces of the adhesive tapes DT.

In addition to the foregoing embodiments, this invention may be embodied variously as follows.

(1) In order to transfer the wafer W onto the new adhesive tape DT, the dice 39 having a surface subject to a release treatment surrounds the adhesive tape DT separated from the ring frame f to cover the adhesive surface of the adhesive tape DT.

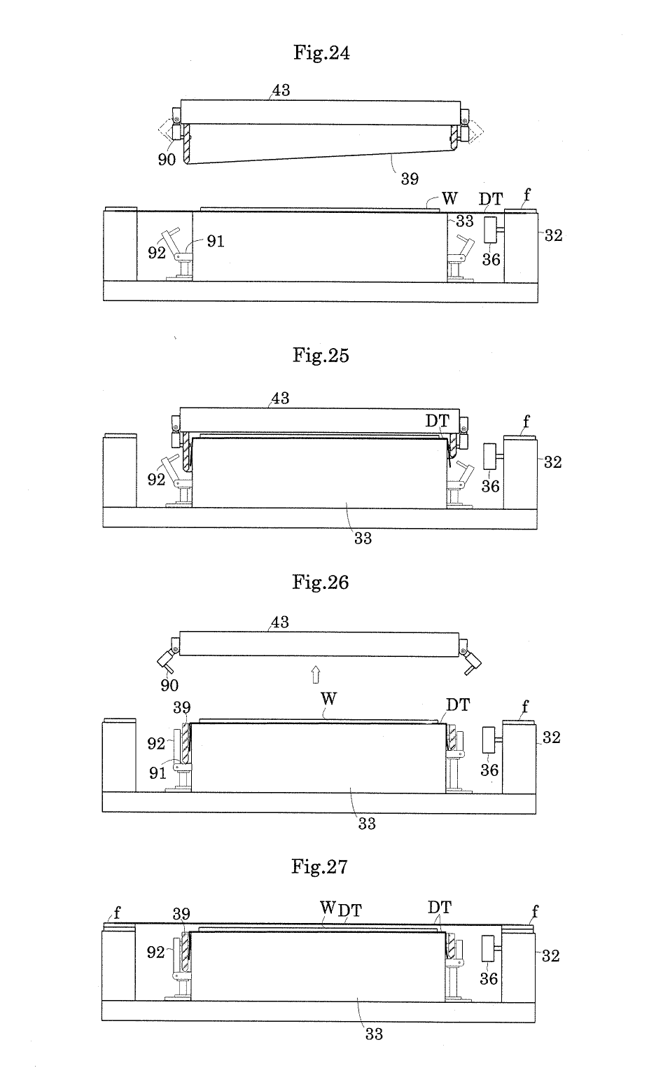

For instance, as shown in FIG. 24, the die 39 is cylindrical and removable from the movable table 43 via an engaging member 90, such as a chuck claw. The wafer holder 33 has receptacles 91 on the side surface thereof for receiving the die 39.

The receptacle 91 has a clamping mechanism 92 that swings toward the side surface of the wafer 33 to hold the adhesive tape DT. The die 39 is received on the receptacles 91. The die 39 has slits on four positions on the outer periphery thereof. The positions conform to the clamping mechanisms 92 that are arranged at equal intervals. Moreover, the slit is engaged with the engaging member 90 of the movable table 43. The receptacle 91 moves upward and downward via a cylinder.

Next, description will be given of transferring the wafer W with use of this configuration.

The mount frame MF is placed over the frame holder 32 and the wafer holder 33. Then as shown in FIG. 25, the separation mechanism 30 operates to separate the adhesive tape DT from the ring frame f while moving the die 39 downward. The die 39 is moved downward to a given level to reach a position where separation of the adhesive tape DT is completed. Then, the receptacle 91 moves upward to receive the tip end of the die 39.

Upon separation, engagement of the die 39 by the engaging member 90 is released as shown in FIG. 26. Then the die 39 is separated from the movable table 43. The movable table 43 moves into its standby position on the upper side. Then the cylinder operates to move the receptacle 91 downward such that the top of the die 39 is lower than the level of the wafer W. Then the clamping mechanism 92 swings toward the slit of the die 39 to clamp and hold the separated adhesive tape DT against the side surface of the wafer holder 33.

The ring frame f joined to a new adhesive tape DT is laminated on the mount frame MF under this state, as shown in FIG. 27. Then, as shown in FIG. 28, the joining roller 46 rolls to join the adhesive tape to the wafer W.

Upon completion of joining the adhesive tape DT, the holding unit 50 sucks a new mount frame MF. Then, as shown in FIG. 30, the receptacle 91 moves downward so as to be retracted from a course of the holding member 36. Then the holding member 36 on the tape collecting section 6 side holds only one end of the adhesive tape DT. The holding unit 50 suction-holds the new mount frame MF under this state to move it obliquely upward into a given level, and then transports it horizontally. The adhesive tape DT is separated from the wafer along with this transportation. Upon completion of separating the adhesive tape DT, the suction member 86 sucks the adhesive tape DT and transports it to the tape collecting section 6.

According to this configuration, the die 39 covers the surface of the separated adhesive tape DT when the new adhesive tape DT is joined to the wafer W. Consequently, the adhesive surfaces of both adhesive tapes can be certainly prevented from adhering to each other.

(2) In the foregoing embodiment, instead of using a new ring frame f for transfer, a new adhesive tape DT may be joined to the ring frame f with the adhesive tape DT separated therefrom to transfer the wafer W. Here, as the adhesive tape DT for transfer, a strip-shaped adhesive tape DT may be joined to the ring frame f, and then may be cut along the contour of the ring frame f. Alternatively, a pre-cut adhesive tape DT cut in advance in a ring-frame shape may be joined to the ring frame f.

(3) In the foregoing embodiment, the adhesive tape DT is joined to the new ring frame f in the tape joining section 15, and then is transported to the separating mechanism 30. Alternatively, the following configuration may be adopted. For instance, a new ring frame f for transfer is laminated on the mount frame MF on the holding table 28. Under this state, the wafer W is joined to the adhesive tape DT while the ring frame f for transfer is joined to the adhesive tape DT. Here, as the adhesive tape DT for transfer, a strip-shaped adhesive tape DT may be joined to the ring frame f, and then may be cut along the contour of the ring frame £ Alternatively, a pre-cut adhesive tape DT cut in advance in a ring-frame shape may be joined to the ring frame f.

(4) The foregoing embodiment includes the frame clamping section 38. The frame clamping section 38 may be omitted as appropriate depending on types of the adhesive tapes DT to be used.

(5) The foregoing embodiment has been described by taking a semiconductor wafer as one example of a substrate. The apparatus is applicable to a substrate having various shapes and sizes, such as a substrate for LED and a circuit board. Consequently, the frame used for supporting the substrate is not limited to the ring frame f for wafer, but a rectangular frame may also be used in accordance with a shape of the substrate to be used. A rectangular frame can suction-hold a plurality of rectangular substrates via the adhesive tape DT, which achieves a reduced dead space. As a result, working efficiency can be enhanced.

(6) In the foregoing embodiment, the ring frame from which the wafer is transferred has the same shape as the new ring frame f to which the wafer is to be transferred. Alternatively, the ring frames having different shapes may be used.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A substrate transfer method for transferring a substrate onto a new adhesive tape, the substrate being adhesively held on a frame via a supporting adhesive tape, the method comprising:
a first separating step holding the frame and the substrate onto each table on a side of the adhesive tape and pressing the adhesive tape between the frame and the substrate by a separation member to separate the adhesive tape from the frame;
a holding step holding the separated adhesive tape by a holding member through bending the adhesive tape toward a table that holds the semiconductor wafer;
a transferring step transferring the substrate onto a new adhesive tape by a joining member on a non-holding surface side of the substrate; and
a second separating step separating from the substrate the adhesive tape separated from the frame while holding the adhesive tape by the holding member and moving the substrate that is transferred onto the new adhesive tape to be integrated with the frame vertically and horizontally.

2. The substrate transfer method according to claim 1, wherein
in the transferring step, the substrate is transferred onto the new adhesive tape through laminating the frame having the new adhesive tape being joined thereto in advance on the frame with the substrate and then pressing the adhesive tape.

3. The substrate transfer method according to claim 1, wherein
in the transferring step, the substrate is transferred onto the adhesive tape through laminating a new frame on the frame with the substrate, and then joining while pressing the adhesive tape to the new frame.

4. The substrate transfer method according to claim 1, wherein
in the transferring step, the substrate is transferred onto the adhesive tape while the adhesive tape is pressed and joined on the non-holding surface side of the frame with the substrate.

5. The substrate transfer method according to claim 1, wherein
the separation member has a slit, and
in the transferring step, an outer periphery of the separated adhesive tape is forcibly bent to be enclosed with the separation member, and the holding member presses the adhesive tape against the side surface of the table for supporting the substrate through the slit of the separation member.

6. The substrate transfer method according to claim 1, wherein
in the second separating step, the adhesive tape remaining on the substrate is separated while the separated adhesive tape is held on one end thereof in a separating direction.

7. A substrate transfer apparatus for transferring a substrate onto a new adhesive tape, the substrate being adhesively held on a frame via a supporting adhesive substrate, the apparatus comprising:
a substrate-holding table for mounting and holding the substrate, the substrate and the frame being joined to the adhesive tape;
a frame-holding table for mounting and holding the frame;
a separation mechanism for pressing the adhesive tape between the frame and the substrate by a separation member to separate the adhesive tape from the frame;
a holding mechanism for holding the separated adhesive tape through bending the adhesive tape toward the substrate-holding table;
a transfer mechanism for transferring the substrate onto a new adhesive tape by a joining member on a non-holding surface side of the substrate; and
a separation unit for separating the separated adhesive tape from the substrate while holding the separated adhesive tape and moving the substrate that is transferred onto the new adhesive tape to be integrated with the frame vertically and horizontally.

8. The substrate transfer apparatus according to claim 7, wherein
the holding member is a clamping mechanism that presses the separated adhesive tape against the side surface of the substrate-holding table.

9. The substrate transfer apparatus according to claim 8, wherein
the separation member has a slit, and forcibly bends and covers an outer periphery of the separated adhesive tape, and
the clamping mechanism presses the adhesive tape at the slit against the side surface of the substrate-holding table.
